(19) United States
(12) Patent Application Publication
(10) Pub. No.: US 2010/0269325 A1
(43) Pub. Date: Oct. 28, 2010

(54) Snap ring expansion tool and method of use

(76) Inventor: Michael P. Hassard, Blue Point, NY (US)

Correspondence Address: BAE SYSTEMS, PO BOX 868, NASHUA, NH, 03061-0868, US

(21) Appl. No.: 12/386,870

(22) Filed: Apr. 24, 2009

(51) Int. Cl. B23P 11/02; B25B 27/20

(52) U.S. Cl. 29/453; 29/229

(57) ABSTRACT

An expansion tool is provided for manipulating a snap ring, comprising a handle defining a longitudinal axis, and a shaft connected with the handle along the longitudinal axis. The shaft is connected with the handle along the longitudinal axis. The shaft defines a front planar face disposed in a substantially perpendicular orientation relative to the longitudinal axis. A wedge extends from the shaft to a tip, and includes a first surface in substantial alignment with an outer surface of the shaft and a second opposing planar surface disposed in a substantially perpendicular orientation relative to the front planar face. The wedge further includes opposing engagement surfaces that each taper from the front planar face to the tip at an angle in a range of approximately 2 to 5 degrees. The engagement surfaces are tapered in a configuration to engage and expand a gap of the snap ring.

### TECHNICAL FIELD

The present disclosure generally relates to hand tools, and more particularly to hand tools for the insertion and removal of snap rings.

### BACKGROUND

Snap rings, or retaining rings, are used in mechanical applications to removably connect springs, collars, and other components to a cylindrical shaft, such as a stud bolt. Snap rings can be manufactured from a strong metal, such as spring steel, for example. Snap rings typically have an inner diameter which is slightly larger than the diameter of the cylindrical shaft to which the snap ring is affixed.

In one example, the cylindrical shaft on which a snap ring is affixed may be provided with an annular groove for receiving the snap ring, which holds the desired component longitudinally along the shaft. Internal snap rings are configured to snap into an annular groove within the interior surface of a hollow cylindrical shaft. External snap rings, on the other hand, are configured to snap into an annular groove on the exterior surface of a cylindrical shaft. Alternatively, snap rings may be configured for mounting on a shaft having at least one longitudinal groove therein. These types of snap rings can include a gap for expansion thereof to facilitate assembly with a shaft.

In particular, to insert either a snap ring configured for use with shafts having an annular groove or a snap ring configured for use with shafts having at least one longitudinal groove, the gap in the snap ring is expanded using a first motion such that the snap ring assumes a diameter which is greater than the diameter of the cylindrical shaft. The snap ring is subsequently positioned in the diameter of the cylindrical shaft. The snap ring is subsequently positioned in the annular groove or the longitudinal groove in the cylindrical shaft using a second motion, in which the snap ring is slidably moved longitudinally along the shaft, to the annular groove or the longitudinal groove. The snap ring is then permitted to reassume its original, unexpanded configuration when the snap ring is positioned in the desired location along the cylindrical shaft, which holds the snap ring in place along the cylindrical shaft. Assembly of these types of snap rings includes expanding the gap. For removal of snap rings, the gap is expanded and displaced from the groove in the shaft and slid along the shaft, away form the grove, for removal therefrom.

Various devices have been developed to insert and/or remove snap rings. For example, pliers are known that have pins for insertion into faces of a snap ring for removal or insertion. However, if the apertures on the faces opposite the gap in the ring are not visible or are otherwise not accessible, these types of tools are ineffective, and if used may separate or damage the snap ring.

Other devices are known for insertion/removal, such as tools for engaging an inner surface of a snap ring for prying the ring from the shaft. These tools are inserted under the snap ring, and pry the snap ring from the shaft. These type of tools, however, require space between the cylindrical shaft and the snap ring, which may or may not be feasible and may disadvantageously cause injury to the user. It has also been known to remove a snap ring using a chisel and hammer which can likely damage parts and carry with it likelihood of injury.

Therefore, it would be desirable to provide a tool for inserting and removing snap rings in a facile and safe manner. Desirably, such a tool inserts and removes snap rings without damaging the snap ring and the cylindrical shaft. It would be most desirable to provide a tool for inserting and removing snap rings which expands the gap in the snap ring such that the snap ring temporarily assumes a diameter which is larger than the diameter of the cylindrical shaft and simultaneously twists the snap ring to permit removal from a cylindrical shaft in a single motion.

### SUMMARY OF THE INVENTION

Accordingly, the present disclosure provides an expansion tool for inserting and removing snap rings which makes insertion and removal simple, safe and quick. Desirably, the expansion tool for inserting and removing snap rings will insert and remove snap rings without damaging the snap ring, the cylindrical shaft, or both. More desirably, the expansion tool for inserting and removing snap rings does not require space between a cylindrical shaft and a snap ring affixed thereto. Further desirably, the expansion tool for inserting and removing snap rings is configured to insert and remove snap rings which do not include an aperture on each face of the ring opposite the gap therein. Most desirably, the expansion tool for inserting and removing snap rings expands the gap in the snap ring such that the snap ring temporarily assumes a diameter which is larger than the diameter of the cylindrical shaft and simultaneously twists the snap ring to permit removal from a cylindrical shaft in a single motion.

In one embodiment, an expansion tool is provided for the insertion and removal of snap rings comprising a handle defining a longitudinal axis, and a shaft connected with the handle along the longitudinal axis. The shaft is connected with the handle along the longitudinal axis. The shaft defines a front planar face disposed in a substantially perpendicular orientation relative to the longitudinal axis. A wedge extends from the shaft to a tip, and includes a first surface in substantial alignment with an outer surface of the shaft and a second opposing planar surface disposed in a substantially perpendicular orientation relative to the front planar face. The wedge further includes opposing engagement surfaces that each taper from the front planar face to the tip at an angle in a range of approximately 2 to 5 degrees. The engagement surfaces are tapered in a configuration to engage and expand a gap of the snap ring.

In another embodiment, the opposing engagement surfaces each taper from the front planar face to the tip of at an angle in a range of approximately 5 to 25 degrees. In one particular embodiment, the opposing engagement surfaces each taper from the front planar face to the tip of at an angle in a range of approximately 5 to 25 degrees. It is envisioned that the tip of the wedge may come to a point, be blunt, or have any other configuration to facilitate the expansion of a snap ring.

In another embodiment, the handle has a circular cross-section. However, it is envisioned that the handle may have a cross-section of any shape, including, rectangular, square, hexagonal, and trapezoidal, for example. In one particular embodiment, the handle is an ergonomic handle. In an alternative embodiment, the handle has an annular recess which is configured to facilitate gripping the expansion tool of the present invention. The expansion tool of the present invention may include a handle having a textured surface to facilitate gripping. It is envisioned that the handle may be textured by, for example, providing a diamond-pattern in the outer surface of the handle. It is understood, however, that the handle may be textured in any manner known in the art suitable to facilitate gripping. In one particular embodiment, an outer sheath configured to fit over the handle is provided to facilitate gripping. It is envisioned that the outer sheath may be made of any material known in the art suitable to facilitate gripping, such as, rubber, for example.

In a preferred embodiment of the tool of the present invention, the handle is about 3.5 inches long, about 2.7 inches wide, and about 2.0 inches high; the shaft is a cylinder about 1.0 inch long with a diameter of about 0.125 inches; and the wedge has a width of about 0.125 inches at the proximal end thereof.

In one embodiment, the tool of the present invention includes a setscrew in the handle configured to secure the shaft in the handle, such that the shaft is removable. Accordingly, another shaft, having a wedge which has a size and/or shape which is different from the wedge of the shaft, may be inserted in the handle in place of the shaft. Indeed, a second shaft having a wedge of a width which is different from the width of the wedge of the shaft may be inserted in the handle in place of the shaft. Therefore, the tool of the present invention may include a plurality of different wedges, each configured to insert and/or remove snap rings of various types and sizes.

In another embodiment, a method is provided for removing a snap ring from its location along a cylindrical shaft, comprising (1) inserting the wedge of the expansion tool of the present invention in the gap of the snap ring and (2) pushing the wedge into the gap until the snap ring expands, such that the snap ring simultaneously twists, causing the snap ring to become dislodged from its location along the cylindrical shaft. Accordingly, removal of a snap ring from its location along the cylindrical shaft is achieved in a single motion. Furthermore, removal of a snap ring from its location along a cylindrical shaft may be achieved using one hand to both insert the wedge of the expansion tool in the gap of the snap ring, and push the wedge into the gap.

It should be understood that the method of the present invention for removing a snap ring from its location along a cylindrical shaft may also be utilized for snap rings which resist to torsion or twisting. In particular, the wedge of the expansion tool of the present invention is first inserted into the gap of a snap ring. The wedge is then pushed into the gap to expand the gap. As the wedge is inserted into the gap, the opposing faces in the gap of the snap ring are moved in opposite directions, thus expanding the gap. The snap ring is subsequently displaced from its location along the cylindrical shaft by slidably moving the snap ring longitudinally along the cylindrical shaft.

In another embodiment, a method is provided for inserting a snap ring onto a cylindrical shaft, comprising (1) inserting the wedge of the expansion tool of the present invention into the gap of the snap ring; (2) pushing the wedge into the gap until the wedge expands the gap in the snap ring; (3) positioning the snap ring in a desired location along the cylindrical shaft; and (4) removing the wedge from the gap of the snap ring, which allows the snap ring to return to its original, unexpanded configuration, thus affixing the snap ring to the cylindrical shaft. It is envisioned that insertion of a snap ring is may be achieved using one hand to insert the wedge of the expansion tool of the present invention in the gap of the snap ring, push the wedge into the gap, position the snap ring in a desired location, and remove the wedge from the gap of the snap ring.

In one particular embodiment, a kit is provided for the insertion and removal of snap rings comprising the expansion tool of the present invention and a second shaft having a wedge, wherein the width of the wedge is different width than the wedge of the shaft of the tool of the present invention. The kit further includes a third shaft having a wedge, wherein the width of the wedge is different than the width of the wedge of the shaft of the expansion tool of the present invention and the width of the wedge of the second shaft. The kit also includes instructions for use. It is envisioned that the kit of the present invention may also include a carrying case for the components of the kit.

### BRIEF DESCRIPTION OF THE DRAWINGS

The features of the present disclosure will become more readily apparent from the specific description accompanied by the following drawings, in which:

FIG. 1 is a front view of a snap ring in accordance with the principles of the present disclosure;

FIG. 2 is a front view of an alternative embodiment of the snap ring shown in FIG. 1;

FIG. 3 is a top view of a snap ring expansion tool in accordance with the principles of the present disclosure;

FIG. 4 is a side view of the tool shown in FIG. 3;

FIG. 5 is a bottom view of the tool shown in FIG. 3;

FIG. 6 is a top view of an alternative embodiment of the tool shown in FIG. 3 in accordance with the principles of the present disclosure;

FIG. 7 is a side view of the shaft and wedge assembly of the tool shown in FIG. 3;

FIG. 8 is a bottom view of the shaft and wedge assembly of the tool shown in FIG. 3; and

FIG. 9 is a cutaway view of the wedge assembly of the tool shown in FIG. 3.

Like reference numerals indicate similar parts throughout the figures.

### DETAILED DESCRIPTION OF THE INVENTION

The exemplary embodiments of the apparatus and methods of the subject invention are discussed in terms of devices and methods for and more particularly, in terms of an apparatus and method for. It is envisioned that the present disclosure may be employed to. It is further envisioned that the present disclosure may be employed with.

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention.

Also, as used in the specification and including the appended claims, the singular forms “a,” “an,” and “the” include the plural, and reference to a particular numerical value includes at least that particular value, unless the context clearly dictates otherwise.

Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

All methods described herein may be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

As used herein, “comprising,” “including,” “containing,” “characterized by,” and grammatical equivalents thereof are inclusive or open-ended terms that do not exclude additional, unrecited elements or method steps, but will also be understood to include the more restrictive terms “consisting of” and “consisting essentially of.”

All publications, patents and patent applications cited in this specification are herein incorporated by reference in their entirety as if each individual publication, patent or patent application were specifically and individually indicated to be incorporated by reference.

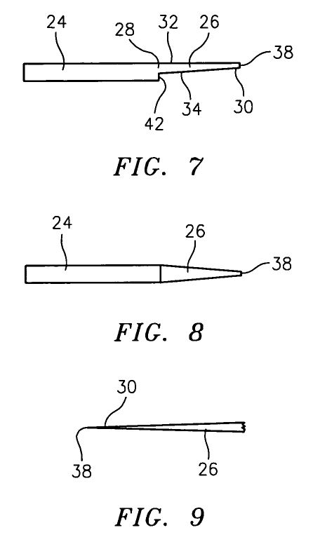

The following discussion includes a description of the apparatus of the subject invention, and related components and exemplary methods of employing the apparatus of the subject invention. Alternate embodiments are also disclosed. Reference will now be made in detail to an exemplary embodiment of the present disclosure, which is illustrated in the accompanying figures. Turning now to FIGS. 1-9, the components of a snap ring expansion tool 20 and related methods of use, in accordance with the principles of the present disclosure, are illustrated.

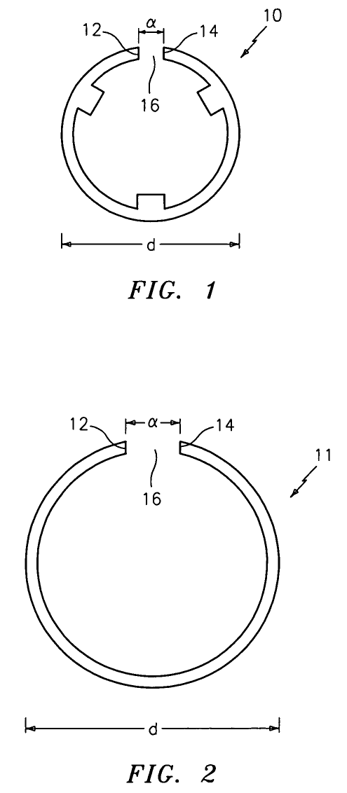

In accordance with the present disclosure, a snap ring expansion tool 20 is provided for the insertion and removal of a snap ring 10 or 11 having a gap 16 spanning a first distance a. It is envisioned that expansion tool 20 may be utilized to insert and remove snap rings such as snap ring 10, as shown in FIG. 1, which is configured for use with shafts having an annular groove. It is also envisioned that expansion tool 20 may be utilized to insert and remove snap rings such as snap ring 11, as shown in FIG. 2, which is configured for use with shafts having at least one longitudinal groove. In particular, expansion tool 20 may be utilized to insert and remove any snap ring that includes a gap, including both internal and external snap rings.

Expansion tool 20 includes a handle 22 defining a longitudinal axis. A first shaft 24 is connected with handle 22 along the longitudinal axis. In particular, first shaft 24 is inserted into a longitudinal aperture within handle 22. In one embodiment, the longitudinal aperture in handle 22 and first shaft 24 are both threaded such that first shaft 24 may be screwed into the longitudinal aperture within handle 22 to secure first shaft 24 therein. It is envisioned that first shaft 24 may be of any size and shape capable of being connected with handle 22. In one embodiment, first shaft 24 is a cylinder about 1.0 inch long having a diameter of about 0.125 inches. First shaft 24 defines a front planar face 42 disposed in a substantially perpendicular orientation relative to the longitudinal axis in handle 22, as shown in FIGS. 4 and 7.

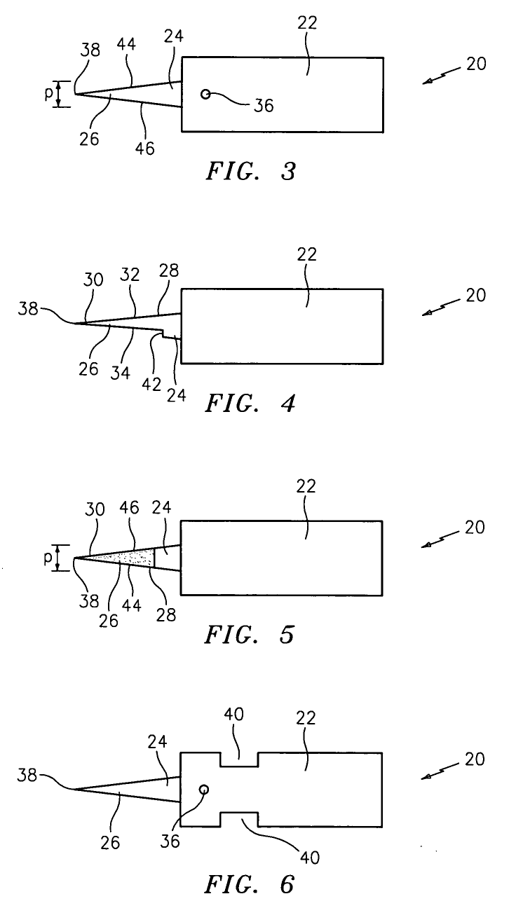

In another embodiment, shown in FIGS. 3 and 6, expansion tool 20 includes a setscrew 36 which is configured to secure first shaft 24 within handle 22. In particular, handle 22 may include a threaded aperture disposed transversely therein through which setscrew 36 passes. As setscrew 36 passes through the threaded aperture in handle 22, setscrew 36 tightens against first shaft 24 to prevent first shaft 24 from moving relative to handle 22. It is envisioned that setscrew 36 may include any type of tip known in the art, such as, a flat point tip, a domed point tip, a cone point tip, a cup point tip, a knurled cup point tip, or a dog point tip, for example. Furthermore, setscrew 36 may include any type of head known in the art, such as, an Allen head, a square head, a slotted head, or a Bristol spline head, for example.

By providing expansion tool 20 with setscrew 36 to secure first shaft 24 within handle 22, first shaft 24 may be removed from handle 22 by removing first shaft 24 from the longitudinal aperture in handle 22, thus allowing another shaft to be inserted into the longitudinal aperture in handle 22. As stated above, first shaft 24 includes wedge assembly 26 disposed on the end thereof. Thus it is envisioned that once first shaft 24 is removed, additional shafts, each having a wedge assembly disposed on the end thereof, may be inserted into the longitudinal aperture within handle 22. It is envisioned that the wedge assemblies of the additional shafts may include proximal ends which have widths which are either longer or short than the width of proximal end 28 of wedge assembly 26. Accordingly, expansion tool 20 may be adapted to include shafts having wedge assemblies of a plurality of different sizes, which can be used interchangeably, depending on the size of the gap in the snap ring to be inserted or removed, for example.

It is envisioned that handle 22 may be of a size and shape to be held in the hand of the user of expansion tool 20, such as the size and shape of the handle of a conventional screwdriver, for example. In one embodiment, handle 22 is about 3.5 inches long, about 2.75 inches wide, and about 2.0 inches high. To facilitate gripping of handle 22, in one embodiment of the present invention, handle 22 includes an annular recess 40, as shown in FIG. 6.

Handle 22 has a circular cross-section. However, it is envisioned that handle 22 may have a cross-section of any shape, including, rectangular, square, hexagonal, and trapezoidal, for example. In one particular embodiment, handle 22 is an ergonomic handle. It is envisioned that handle 22 may be manufactured of materials known in the art such as, wood, plastic, aluminum, steel, for example.

Wedge assembly 26 is formed with the end of first shaft 24 distant from handle 22. As such, wedge assembly 26 and first shaft 24 are monolithic. Wedge assembly 26 includes a proximal end 28 and a distal end 30. Wedge assembly 26 extends from first shaft 24 to a tip 38, and includes a first surface 32 in substantial alignment with an outer surface of first shaft 24 and a second opposing planar surface 34 disposed in a substantially perpendicular orientation relative to front planar face 42. Wedge 26 further includes opposing engagement surfaces 44 and 46 that each taper from front planar face 42 to tip 38 at an angle in a range of approximately 2 to 5 degrees.

In another embodiment, opposing engagement surfaces 44 and 46 each taper from front planar face 42 to tip 38 of at an angle in a range of approximately 5 to 25 degrees. In one particular embodiment, opposing engagement surfaces 44 and 46 each taper from front planar face 42 to tip 38 of at an angle in a range of approximately 25 to 50 degrees. Tip 38 may come to a point, be blunt, or have any other configuration to facilitate the expansion of a snap ring.

However, it should be understood that the amount in which opposing engagement surfaces 44 and 46 each taper from front planar face 42 to tip 38 is dependent upon the width of gap 16 in snap ring 10 or 11 and/or the amount of space between snap ring 10 or 11 and the cylindrical shaft to which it is connected. Indeed, the wider gap 16 is, and the less space there is between snap ring 10 or 11 and the cylindrical shaft to which it is attached, the less opposing engagement surfaces 44 and 46 can be tapered from front planar face 42 to tip 38. Conversely, the narrower gap 16 is, and the more space there is between snap ring 10 or 11 and the cylindrical shaft to which it is attached, the more opposing engagement surfaces 44 and 46 can be tapered from front planar face 42 to tip 38.

Distal end 30 of wedge assembly 26 is inserted into the gap of a snap ring, such as gap 16 in snap ring 10 or 11, to expand the gap so that the snap ring can be inserted or removed. As distal end 30 is inserted into gap 16, first face 12 and second face 14 are moved in opposite directions, thus expanding gap 16. Accordingly, the width of proximal end 28 is at least a second distance β. Second distance β is greater than first distance α, such that wedge assembly 26 expands gap 16 in a snap ring when proximal end 28 is inserted therein. Distal end 30 of wedge assembly 26 has a tip 38 which is pointed. However, it is envisioned that tip 38 of wedge assembly 26 may be blunt, without departing from the spirit of the invention.

It is envisioned that wedge assembly 26 may be of any size and shape to expand the gap in a snap ring, such as gap 16 in snap ring 10 or 11, when wedge assembly 26 is inserted into handle 22. In one embodiment, wedge assembly is about 0.125 inches at proximal end 28. In one embodiment, second opposing planar surface 34 is flat. However, it is envisioned that second opposing planar surface 34 may be concave or convex, without departing from the spirit of the present invention.

First shaft 24 may be manufactured from any material known in the art, such as, aluminum, steel, for example. Wedge assembly 26 may be manufactured from any material known in the art, such as, aluminum, steel, for example.

In use, a method is provided for inserting a snap ring, such as snap ring 10 or 11, having a gap 16 spanning a first distance α onto a cylindrical shaft, in which distal end 30 of wedge assembly 26 is first inserted into the gap of a snap ring 10 or 11, such as gap 16 in snap ring 10 or 11. Wedge assembly 26 is then pushed into gap 16 until proximal end 28 of wedge assembly 26 expands gap 16 in snap ring 10 or 11 to a second distance β, second distance β being greater than first distance a. In particular, as distal end 30 is inserted into gap 16, first face 12 and second face 14 are moved in opposite directions, thus expanding gap 16. Next, snap ring 10 or 11 is positioned in a desired location along the cylindrical shaft. Distal end 30 of wedge assembly 26 is then removed from gap 16 of snap ring 10 or 11, which permits gap 16 to reassume its original, unexpanded configuration, to a first distance α, thus affixing snap ring 10 or 11 to the cylindrical shaft.

Alternatively, a method is provided for removing a snap ring from its location along a cylindrical shaft, such as snap ring 10 or 11 having a gap 16, in which distal end 30 of wedge assembly 26 is first inserted into gap 16 of snap ring 10 or 11. Wedge assembly 26 is then pushed into gap 16 until proximal end 28 of wedge assembly 26 expands gap 16 to a second distance β, which is wider than first distance α, which corresponds to the original, unexpanded size of gap 16. In particular, as distal end 30 is inserted into gap 16, first face 12 and second face 14 are moved in opposite directions, thus expanding gap 16. As gap 16 expands to second distance β, snap ring 10 or 11 begins to twist, which in turn causes snap ring 10 or 11 to pop off the cylindrical shaft to which it was connected. Accordingly, snap ring 10 or 11 is removed from its location along a cylindrical shaft with expansion tool 20 using a single motion. It is envisioned that the removal of snap ring 10 or 11 from its location along the cylindrical shaft using expansion tool 20 may be achieved using one hand to both insert distal end 30 of wedge assembly 26 in gap 16 of a snap ring 10 or 11, and push wedge assembly 26 into gap 16.

In that snap rings are typically thin and flat from edge to edge, snap rings are susceptible to torsion or twisting. Indeed, snap rings generally lack strength in torsion along an axis extending the length of the snap ring parallel to the flat surface of the snap ring. Accordingly, as a gap in a snap ring is expanded beyond its original, unexpanded configuration, the shape of at least a portion of the snap ring is changed from a flat surface to a twisted surface. As the shape of at least a portion of the snap ring is changed from a flat surface to a twisted surface, the portion of the snap ring which engaged the cylindrical shaft is moved up or down, depending on how the snap ring is twisted. Moving the portion of the snap clip which engaged the cylindrical shaft displaces the snap ring from its position along a cylindrical shaft such that the snap ring can be removed by sliding the snap ring over one end of the cylindrical shaft.

In another embodiment, a method for removing snap rings which are resistant to torsion or flexing having a gap 16 from a position along a cylindrical shaft is provided. In particular, distal end 30 of wedge assembly 26 is first inserted into gap 16 of a snap ring 10 or 11. Wedge assembly 26 is then pushed into gap 16 until proximal end 28 of wedge assembly 26 expands gap 16 to a second distance β, which is wider than first distance α, which corresponds to the original, unexpanded size of gap 16. In particular, as distal end 30 is inserted into gap 16, first face 12 and second face 14 are moved in opposite directions, thus expanding gap 16. The snap ring is subsequently displaced from its location along the cylindrical shaft by slidably moving snap ring 10 or 11 longitudinally along the cylindrical shaft.

In another embodiment, a kit is provided for the insertion and removal of snap rings, such as snap ring 10 or 11 having a gap 16 spanning a first distance a, which include expansion tool 20. In addition to expansion tool 20, a second shaft having a wedge assembly which includes a proximal end and a distal end is included in the kit of the present invention, wherein the width of the proximal end is a third distance. The third distance is different from first distance a or second distance β. The kit of the present invention further includes a third shaft having a wedge assembly which includes a proximal end and a distal end, wherein the width of the proximal end is a fourth distance. The fourth distance is different from first distance α, second distance β or the third distance. Instructions to insert or remove a snap ring using expansion tool 20 are also provided.

The kit of the present invention may further include at least one shaft having a wedge assembly which includes a proximal end and a distal end, wherein the width of the proximal end is a distance which is different from first distance α, second distance β, the third distance, or the fourth distance. Thus, the kit of the present invention permits the insertion and removal of snap rings of various sizes via use of a plurality of wedge assemblies having varying widths. In particular, first shaft 24 may be removed by unscrewing setscrew 36, which allows first shaft 24 to be removed from handle 22 by slidably moving first shaft 24 out of the longitudinal aperture in handle 22. Additional shafts, each having a wedge assembly which includes a proximal end and a distal end, wherein the width of the proximal end is different than the width of proximal end 28 of wedge assembly 26, may then be inserted into handle 22. It is envisioned that the wedge assemblies of the additional shafts may include proximal ends which have widths which are either longer or short than the width of proximal end 28 of wedge assembly 26.

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

What is claimed is:

1. An expansion tool for manipulating a snap ring, the expansion tool comprising:
a handle defining a longitudinal axis;
a shaft connected with the handle along the longitudinal axis, the shaft defining a front planar face disposed in a substantially perpendicular orientation relative to the longitudinal axis; and
a wedge extending from the shaft to a tip, the wedge including a first surface in substantial alignment with an outer surface of the shaft and a second opposing planar surface disposed in a substantially perpendicular orientation relative to the front planar face, the wedge further including opposing engagement surfaces that each taper from the front planar face to the tip at an angle in a range of approximately 2 to 5 degrees, the engagement surfaces being tapered in a configuration to engage and expand a gap of the snap ring.

2. The tool of claim 1, wherein the handle has a textured surface to facilitate gripping.

3. The tool of claim 1, wherein the handle has a circular cross-section.

4. The tool of claim 1, further comprising a setscrew in the handle configured to secure the shaft in the handle such that the shaft is removable.

5. The tool of claim 4, further comprising at least one second shaft connected in the handle in place of the shaft, the at least one second shaft having a wedge extending from the at least one second shaft, wherein the width of the wedge of the at least one second shaft is different from the width of the wedge of the shaft.

6. The tool of claim 1, wherein the shaft has a recess therein for gripping the tool.

7. The tool of claim 1, wherein the opposing engagement surfaces each taper from the front planar face to the tip of at an angle in a range of approximately wedge is tapered about 5 to about 25 degrees.

8. The tool of claim 7, wherein the opposing engagement surfaces each taper from the front planar face to the tip of at an angle in a range of approximately wedge is tapered about 25 to about 50 degrees.

9. The tool of claim 1, wherein the tip of the wedge comes to a point.

10. The tool of claim 1, wherein the tip of the wedge is blunt.

11. The tool of claim 1, wherein the handle is about 3.5 inches long, about 2.7 inches wide, and about 2.0 inches high; the shaft is a cylinder about 1.0 inch long with a diameter of about 0.125 inches; and the wedge has a width of about 0.125 inches.

12. The tool of claim 1, wherein the handle is an ergonomic handle.

13. A method for removing a snap ring from a location along a cylindrical shaft, comprising:
inserting the wedge of the tool of claim 1 in the gap of the snap ring; and
pushing the wedge into the gap until the wedge expands the gap in the snap ring, such that the snap ring simultaneously twists, causing the snap ring to become dislodged from the cylindrical shaft.

14. The method of claim 13, wherein removal of a snap ring from a location along the cylindrical shaft is achieved in a single motion.

15. The method of claim 13, wherein removal of a snap ring from a location along the cylindrical shaft is achieved using one hand to both insert the wedge of the tool of claim 1 in the gap of the snap ring, and push the wedge into the gap.

16. A method for inserting a snap ring to a location along a cylindrical shaft, comprising:
inserting the wedge of the tool of claim 1 into the gap of the snap ring;
pushing the wedge into the gap until the wedge expands the gap in the snap ring;
positioning the snap ring in a desired location along the cylindrical shaft; and
removing the wedge from the gap of the snap ring, thus affixing the snap ring to the cylindrical shaft.

17. The method of claim 16, wherein insertion of a snap ring to a location along a cylindrical shaft is achieved using one hand to insert the wedge of the tool of claim 1 in the gap of the snap ring, push the wedge into the gap, position the snap ring in a desired location, and remove the wedge from the gap of the snap ring.

18. A kit for manipulating a snap ring, comprising:
the tool of claim 1;
a second shaft having a wedge, wherein the width of the wedge is different width than the wedge of the shaft of the tool of claim 1;
a third shaft having a wedge, wherein the width of the wedge is different than the width of the wedge of the shaft of the tool of claim 1 and the width of the wedge of the second shaft; and
instructions for use.

19. The kit of claim 18, further comprising at least one shaft having a wedge, wherein the width of the wedge is different than the width of the wedge of the shaft of the tool of claim 1, the width of the wedge of the second shaft, and the width of the wedge of the third shaft.

20. The kit of claim 18, further comprising a carrying case.
